(19) United States
(12) Patent Application Publication
(10) Pub. No.: US 2006/0241216 A1
(43) Pub. Date: Oct. 26, 2006

(54) Adjustably biodegradable material for a horticultural container and overpackaging for containers

(76) Inventors: Jean-Pierre Varachez, Jaunay-Clan (FR); Jacques Barbier, Montamise (FR)

Correspondence Address: YOUNG & THOMPSON, 745 SOUTH 23RD STREET, 2ND FLOOR, ARLINGTON, VA, 22202, US

(21) Appl. No.: 10/550,693

(22) PCT Filed: Mar. 17, 2004
(86) PCT No.: PCT/FR04/50110

§ 371 Date: Apr. 26, 2006

(30) Foreign Application Priority Data
Mar. 17, 2003 (FR) 03/03227

(51) Int. Cl. C08G 18/38

(52) U.S. Cl. 524/35

(57) ABSTRACT

The object of the invention is a printable material with adjustable biodegradability, usable particularly for the production of horticultural containers and/or over-packaging for containers, characterized in that it comprises a mixture of polycaprolactone and polystyrene, including a vegetable load.

The present invention relates to a material with adjustable biodegradability for the production of horticultural containers or for overpackaging of containers. There are known horticultural containers that are well adapted as to their shape, permitting the culturing and raising of vegetables. Such containers constitute a substantial progress relative to containers made of a non-degradable material, derived from petroleum products, generally black in color, the color being caused by loads necessary for their production.

An important drawback of these containers was their inability to be printed, but the development is such that the containers themselves should be able to carry printed messages, either to reproduce image data or textual data associated with the plant in the container.

Such a container in the prior art having provided a substantial improvement in the supply is described and claimed in international patent application WO/FR02 03037, in the name of the same applicant.

This application proposes a container made of a printable material with high definition, whose geometry permits the use of automated machines for potting, which is carried out from starting with a cutout blank after having been printed, which permits the respiration of the vegetables even when the containers rest on a surface saturated with water or fertilizer liquid.

There can thus be provided on the container directly the data on the product, the date/age of the plant, the coordinates of the producer, information on the conditions of planting of the vegetable by the buyer, suggestions as to growth and progress, all augmented by illustrations which are self-explanatory, which avoids the loss of labels and all the drawbacks connected with removability of known information systems.

This container should be made of a material whose biodegradable qualities are completely suitable.

Moreover, and not only, it would be desirable to have a biodegradable material which also has adjustable biodegradability over time.

Certain plants require a duration of conservation of six months, whilst others must be conserved for two or three years to give a proper size. This biodegradability must thus be adjusted.

After use, it is necessary to dispose of the empty containers, but the biodegradability should then be rapid. This involves a true biodegradability, which is to say a total elimination by the work of microorganisms and not only degradation by radiation such as ultraviolet which degrades more by fragmentation.

It will be seen from meeting these criteria that the suppliers are faced with slightly conflicting conditions: it is necessary that the container be physically intact during a certain duration corresponding to the presentation and sale, hence with good preservation of the printing, because it degrades rapidly to ensure its elimination.

Moreover, during this duration in which the container must remain intact, it is necessary that it can be watered, in contact with treatment and/or fertilizing products, without thereby degrading.

This container must also have suitable mechanical properties and particularly it must continue to be able to be handled, without deformation, and without delamination or curling.

There are also known U.S. Pat. Nos. 3,852,913 and 3,919,163, which describe a biodegradable material permitting the production of specific containers.

Thus, so as to ensure reforestation, there are provided plantation machines which use implantation guns. Because of this, it is necessary to design the contents in the shape of an ogive which will be introduced directly into the ground with the plant inside, by this gun.

Because of this, there must be sufficient mechanical resistance of the container to permit this operation but while ensuring that biodegradability to ensure the free development of the plant and the lack of pollution of the ground with each implantation.

This material is based on polymers of the family of caprolactones either in the form of homopolymers or in the form of propolymers with polymers obtained by condensation completed with loads, talc, silica, carbon and/or plastifiers, fertilizers, pesticides, fungicides or insecticides.

There can be cited in this same family of products U.S. Pat. No. 3,929,937.

It will be noted that the problem posed is totally different and it will be seen that the problem of printability does not in any way arise, similarly as the adjustment of the durability in an intact form.

Thus, it suffices that the container be sufficiently rigid during a given period to permit forcible introduction into the ground even if during this operation there is degradation or mechanical fragmentation, or on the contrary, such fragmentation permits the development of roots more rapidly.

It will be seen that in this case, another notable difference relates to the manner of planting because in the case of these processes, the plant is implanted in its container.

The object of the present invention is a material whose biodegradation time is adjustable, which is adapted to be calandered, which is printable under printing conditions and drying conditions of the inks comparable to the existing ones and whose mechanical properties are themselves suitable.

To this end, the material usable for the production of horticultural containers with adjustable biodegradability and that are printable, is characterized in that it comprises a mixture of polycaprolactone, and of polystyrene, incorporating a vegetable load.

More particularly, the mixture comprises 50 to 70% by weight of polycaprolactone and 50 to 30% by weight of polystyrene, the vegetable load varying from 15 to 50% by weight of the whole.

The vegetable load is selected from heat and/or corn and/or cellulose.

According to a preferred embodiment, the mixture comprises 60% by weight of polycaprolactone and 40% by weight of polystyrene, the vegetable load being 30% by weight of the whole.

The invention also covers the process for production of a sheet of material by calandering as well as the horticultural container with adjustable biodegradability and printability that is produced.

The invention also relates to a process of production of a horticultural container with adjustable biodegradabilty while preserving printability, which is characterized in that the quantity and nature of the vegetable charge is varied to adjust the biodegradability, with substantially constant mechanical parameters.

The material according to the invention will now be described in detail with its process of production.

The accompanying drawings show curves of the results obtained for this material permitting characterizing the material.

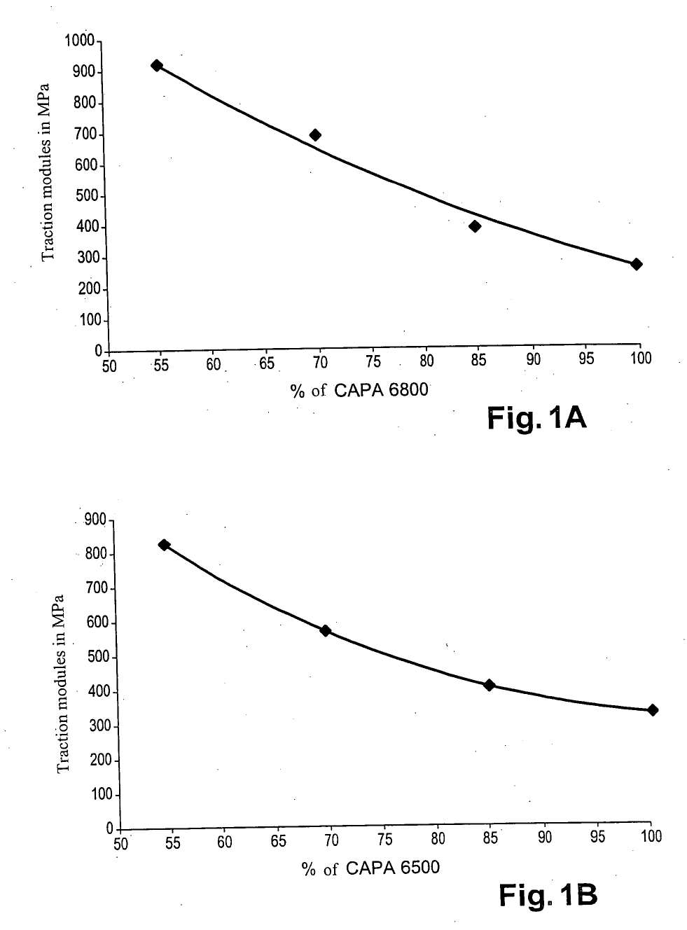

FIGS. 1A and 1B: traction modulus as a function of the compositions of the mixture for CAPA 6500 and 6800.

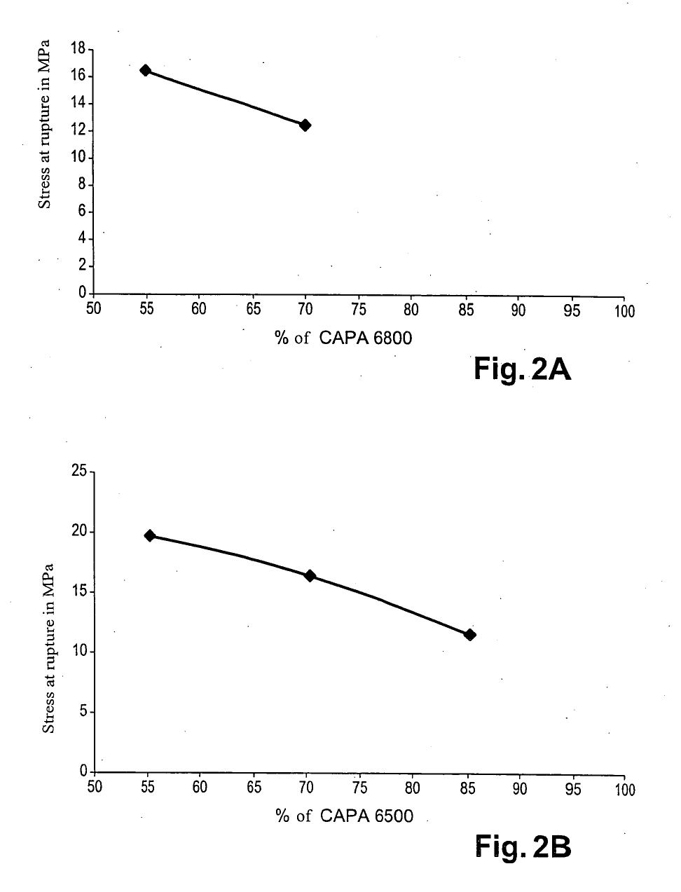

FIGS. 2A and 2B: rupture stress as a function of the compositions of mixture for CAPA 6500 and 6800.

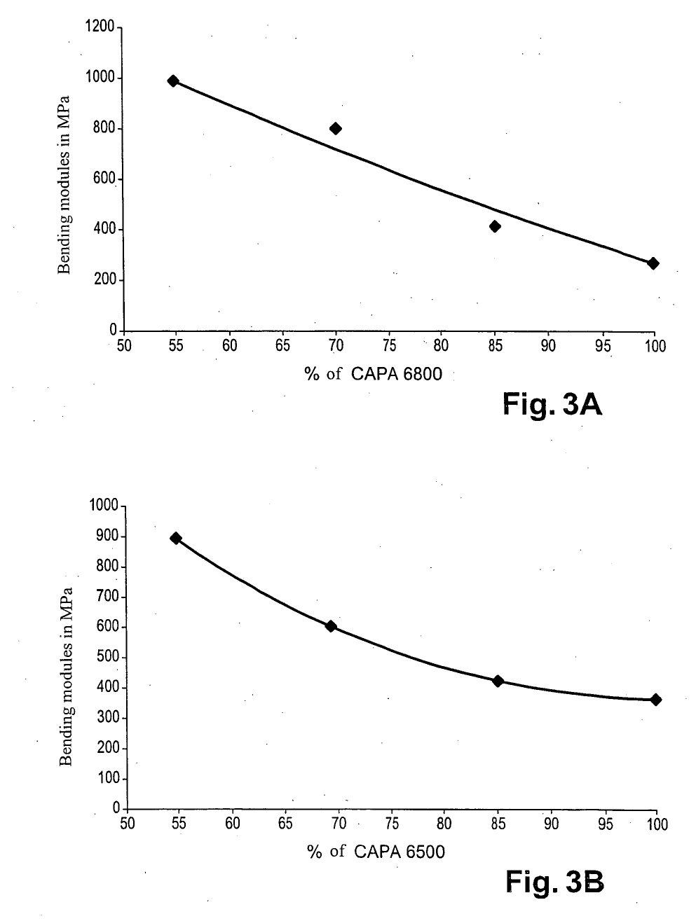

FIGS. 3A and 3B: bending modulus as a function of the compositions of the mixture for CAPA 6800 and 6500.

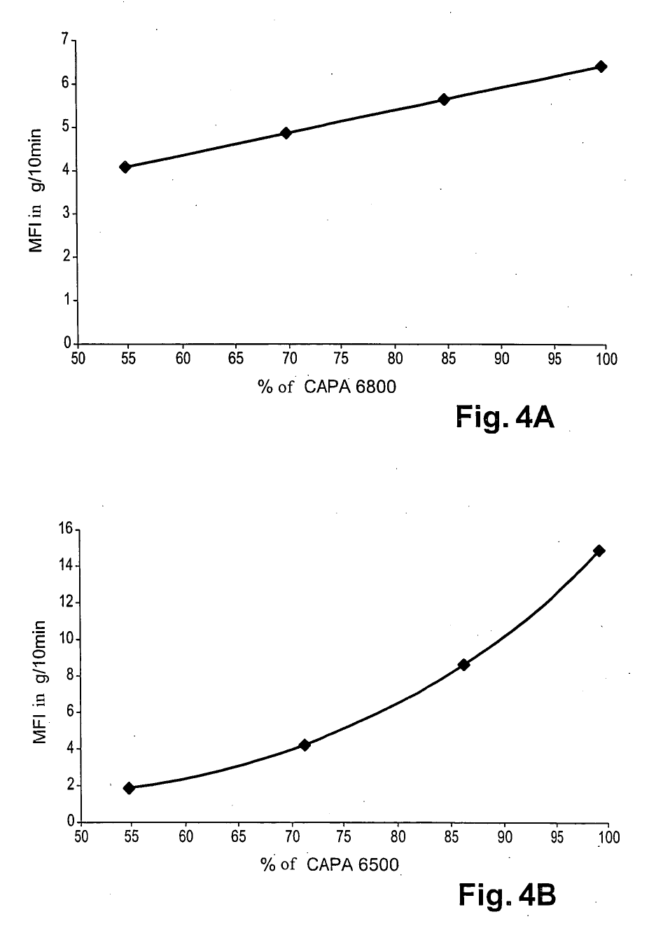

FIGS. 4A and 4B: index of viscosity (MFI) as a function of the compositions of the mixture for CAPA 6800 and 6500, and

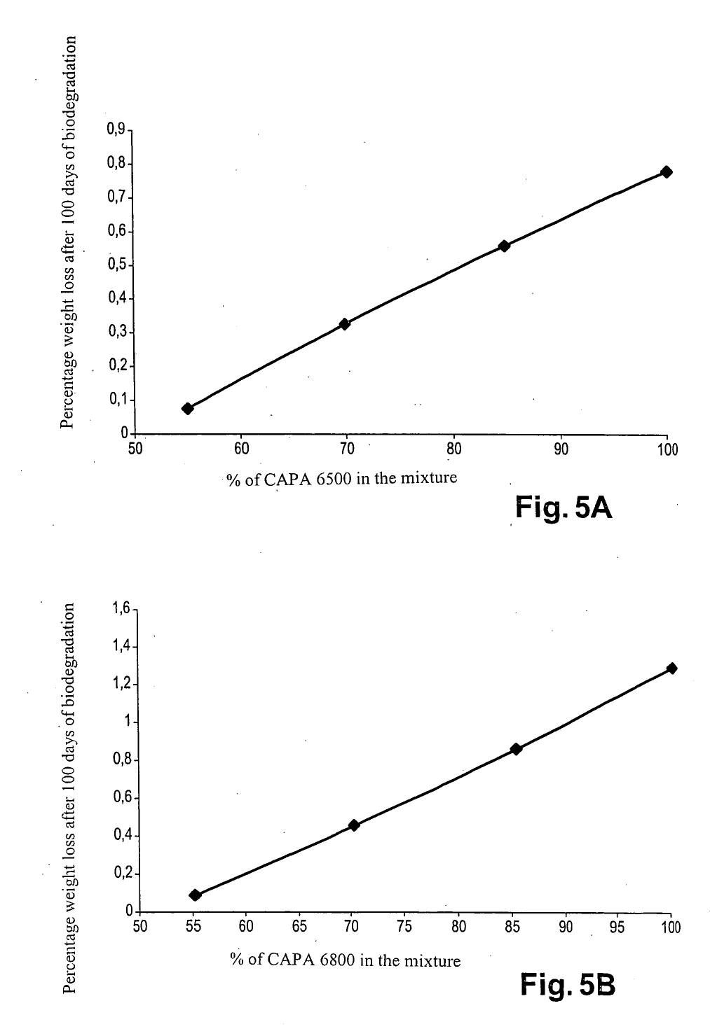

FIGS. 5A and 5B: index of the biodegradability by loss of weight expressed as a percentage as a function of the compositions of the mixtures for CAPA 6500 and 6800.

I/ Analysis of the Pure Polymer:

The material is taken from the family of polycaprolactones which undergo additions permitting responding to all of the requirements.

The polycaprolactones cannot be used alone to achieve the desired performances and particularly adjustable biodegradability.

Moreover, it is necessary that the material be able to be calandered, namely, printable without corona treatment, that the sheets thus obtained after calandering can be cut out, scored and folded and then cemented.

Because of this, it is necessary to add the loads, plastifiers and/or rigidifiers.

There are selected two bases of capralactones having different grades. It is thus known that the grade corresponds to a viscosity which itself reflects a molecular weight.

Tests are then conducted of the introduction of polystyrene, particularly shock polystyrene which is the associated polymer.

This polymer is introduced in the amount of 15, 30 and 45%.

The mechanical properties studied are:
a) traction modulus,
b) stress at rupture
c) bending modulus
d) MFI which is the Melt Flow Index or the index of fluidity, and
e) biodegradability in aqueous medium.

The mixture is made by compounding which is a mechanical preparation with maxilating, melting, mixing, extrusion, cooling and granulation by cutting of extruded strands.

Standard specimens are then made by injection so as to permit measurements of the different parameters achieved.

The two products of commerce are polycaprolactones available from the Solvay company and known under the names CAPA 6500 and 6800.

a) Traction Modulus

FIGS. 1A and 1B show the curves obtained of the traction moduli. Ratios of the order of 50% and 70% of each of the two polycaprolactones used and hence of 50% and 30% of polystyrene, permit achieving the desired values for the production of containers with volume dimensions of the order of a cubic decimeter.

b) Rupture Stress

FIGS. 2A and 2B show the obtained curves.

It will be noted that with high concentrations of polycaprolactones, the deformation takes place with elongation without rupture.

The best compromise to produce horticultural containers consists in introducing between 50 and 70% of polycaprolactone, this with the same grade and the balance in polystyrene.

c) Bending Modulus

Breaking is never reached for the two grades used hence in the composition within the range of 50 to 70% of polycaprolactone with the balance of polystyrene.

The resulting curves obtained for the two grades 6800 and 6500 are combined in FIGS. 3A and 3B.

d) Index of Fluidity

The measurements are carried out with a plastometer, commercially known as “ZWICK”. It relates to the index of fluidity when hot, as to weight and volume. Extrusion takes place under constant weight of the volumes of polymer through a given spinneret at a fixed and constant temperature.

The fixed parameters are the working temperature, the weight of the load exerted and the duration of extrusion.

The desired being a flow rate of the order of 3 to 5 g each ten minutes, the range of values should be maintained, comprised between 50 and 70% of polycaprolactone for the two grades.

It will be noted that normally, the polycaprolactone index lower than 6500 and hence lower molecular weight, permits obtaining a greater fluidity.

Such a parameter is important to permit satisfactory calandering of the sheets provided to be printed, cut, folded and glued.

The results are in the form of curves, and show both 6800 and 6500 in FIGS. 4A and 4B.

f) Biodegradability

The results are assembled in the curves of FIGS. 5A and 5B.

The test is carried out by immersion in pure water for 100 days in the course of which the loss of material is measured after cold drying.

There is seen a biodegradability which increases with the percentage of polycaprolactone.

The choice of duration permits having significant values but the duration of 100 days is not indicative of real times adapted to be achieved.

II/ Analysis of the Polymer with a Vegetable Load:

So as to adjust the biodegradability, according to the invention, there is included with the polycaprolactone/polystyrene mixture a vegetable load.

The tests related to mixtures of CAPA 6500/polystyrene in a ratio comprised between 50 and 70% of polycaprolactone.

A vegetable load is comprised between 15 and 50%. It is selected from corn flour, what flour and cellulose flour, in this instance lupine tusks so as to permit covering all the range necessary for duration of biodegradability.

The parameters analyzed are the mechanical properties and biodegradabilty.

A/ Mechanical Properties:

1/Variations of Type of Load

The 70/30 mixture used comprises 70% of polycaprolactone and 30% of polystyrene because it is the mixture known to have values that are already satisfactory.

| | Modulus of | Bending | Rupture | |
|---|---|---|---|---|
| | traction | modulus | traction | Fluidity |
| | (MPa) | (MPa) | (MPa) | index |
| Pure | 581 | 543 | 11.2 | 4.8 |
| mixture | | | | |
| Wheat | 788 | 1013 | 11.3 | 2.0 |
| (35%) | | | | |
| Corn (35%) | 713 | 871 | 10.9 | 1.5 |
| Cellulose | 743 | 937 | 13.8 | 1.4 |
| (35%) | | | | |

The mechanical properties are improved by the vegetable load, with a constant vegetable load at 35% by weight of the whole.
2/Variations of the Quantity of Vegetable Load:

Tests bearing on a 60/40 mixture with a load of lupine husk flour hence of cellulose in quantities of 15, 30 and 50%.

Variation of the mechanical properties is studied.

| | Modulus of | Bending | Rupture | |
|---|---|---|---|---|
| | traction | modulus | traction | Fluidity |
| | (MPa) | (MPa) | (MPa) | index |
| Pure | 713 | 762 | 15.4 | 3.0 |
| mixture | | | | |
| Cellulose | 998 | 1274 | 17.1 | 1.4 |
| (15%) | | | | |
| Cellulose | 1181 | 1281 | 12.9 | 1.9 |
| (30%) | | | | |
| Cellulose | 866 | 1047 | 15.4 | 1.9 |
| (50%) | | | | |

It will be seen that the increase of the mechanical properties is optimum as to the cellulose when the load is of the order of 30%.

Other tests show, particularly for wheat and corn, that the mechanical properties are improved also in the range of 15 to 50% of vegetable load.

3/Variations in the Quantity of Polycaprolactone:

There is analyzed the variation of the quantity of caprolactone, 50, 60 and 70%, the polystyrene varying proportionally, with a constant vegetable load, in this instance 30%, on the mechanical properties, in this instance for wheat, corn and cellulose.

| | Modulus of | Bending | Rupture | |
|---|---|---|---|---|
| | traction | modulus | traction | Fluidity |
| | (MPa) | (MPa) | (MPa) | index |
| Wheat (30%) | | | | |
| Mixture | 1068 | 1343 | 18.4 | 1.2 |
| (50/50) | | | | |
| Mixture | 1181 | 1281 | 12.9 | 1.9 |
| (60/40) | | | | |
| Mixture | 788 | 1013 | 11.3 | 2 |
| (70/30) | | | | |
| Corn (30%) | | | | |
| Mixture | 1067 | 1326 | 19.3 | 1.3 |
| (50/50) | | | | |
| Mixture | 942 | 1072 | 16.3 | 1.9 |
| (60/40) | | | | |
| Mixture | 713 | 871 | 10.9 | 1.5 |
| (70/30) | | | | |
| Cellulose (30%) | | | | |
| Mixture | 1095 | 1485 | 17.8 | 1.3 |
| (50/50) | | | | |
| Mixture | 1171 | 1349 | 14.7 | 1.9 |
| (60/40) | | | | |
| Mixture | 743 | 936 | 13.8 | 1.4 |
| (70/30) | | | | |

The value of 60% of polycaprolactone/40% of polystyrene is again seen to be particularly interesting.

B/ Biodegradability:

1/Variation of the Types of Load

This study is carried out by measuring the loss of mass of the specimens immersed in water, at the end of 300 hours.

The mixture used is intermediate and comprises 60% of polycaprolactone and 40% of polystyrene.

There are used vegetable loads of 35%.

| | Loss of mass in % at 300 h |
|---|---|
| Mixture (60/40)/Wheat (35%) | −1.2 |
| Mixture (60/40)/Corn (35%) | −0.6 |
| Mixture (60/40)/ | −4.2 |
| Cellulose (35%) | |

There is noted a very strong biodegradability with the use of cellulose.

2/Variations in Quantity of Load:

Tests were carried out with variable vegetable loads with the same type of load.

For the tests that follow, there was used corn flour in proportions of 15, 30 and 50%.

| | Loss of mass in % at 300 h |
|---|---|
| Mixture (60/40)/Corn (15%) | −0.03 |
| Mixture (60/40)/Corn (30%) | −0.48 |
| Mixture (60/40)/Corn (50%) | −0.78 |

There is noted a variation in the biodegradability over a very large range because the loss is multiplied by a coefficient of nearly 30 for corn over the range from 15 to 50% by weight of vegetable load.

For wheat, there are obtained variations of nearly 10 and for cellulose nearly 5.

3/Variations in the Quantity of Polycaprolactone:

Variation in the quantity of polycaprolactone is analyzed, for a constant vegetable load of 50, 60 and 70%, in this instance 30%, on the biodegradability, in this instance for wheat, corn and cellulose.

| | Loss of mass in % at 300 h |
|---|---|
| Wheat (30%) | |
| Mixture (50/50) | −0.97 |
| Mixture (60/40) | −2.15 |
| Mixture (70/30) | −1.80 |
| Corn (30%) | |
| Mixture (50/50) | −0.48 |
| Mixture (60/40) | −1.03 |
| Mixture (70/30) | −0.70 |
| Cellulose (30%) | |
| Mixture (50/50) | −2.04 |
| Mixture (60/40) | −5.03 |
| Mixture (70/30) | −4.60 |

It can be deduced from this that the range of values of 50 to 70% of polycaprolactone is satisfactory and that the ratio 60% polycaprolactone/40% polystyrene is optimum.

C/ Printability

Once the loaded product is obtained, it is necessary the verify the possibilities of printing, here for different criteria which are the printability itself but also brilliance, drying, rigidity, whitening of the product after calandering and opacity.

The comparison is made between the product with 70% polycaprolactone/30% polystyrene and the best recyclable commercial product and actually used in the scope of the field of activity of the mentioned patent application WO/FR02 03038 in the name of the same owner.

The scale varies from 1 to 5, for each of the parameters.

| | Print- | | | | | |
|---|---|---|---|---|---|---|
| | ability | Brilliance | Drying | Rigidity | Whitening | Opacity |
| Reference | 2 | 3 | 2 | 5 | 4 | 5 |
| Mixture | 3 | 3 | 2 | 4 | 5 | 5 |
| 70/30 | | | | | | |

It will again be seen that only the rigidity is slightly less whilst all the other parameters are at least as interesting, even greater, as to pure printability and as to whitening, which permits a better approach to colors.

Obtaining sheets of this material is carried out preferably by calandering.

The horticultural containers are then obtained by cutting out blanks from the sheets of material with controlled biodegradability. A particularly satisfying blank is that produced according to the teaching of the mentioned patent application WO/FR02 03037 in the name of the same owner, which is introduced into the present application as to the geometric characteristics of the container described therein.

For carrying out this calandering, there can then be added additives to facilitate the calandering operations, particularly plastifiers which are introduced in very small quantities and which do not modify the properties described above, or whitening agents such as titanium oxide.

The applications of the present invention relate to horticultural containers in the broad sense of plants no matter what the variety.

Tests have shown moreover that this material has no toxicity as to plants.

In a known manner, it is also possible to add fungicidal, insecticidal, fertilizing agents to this material if necessary without thereby departing from the present invention.

The material is also particularly suitable for producing over-packaging which will surround the containers.

Thus, such over-packaging is very useful because it is printable and can carry all the necessary information for commercialization and can receive containers quite different from those of the present invention such as peat pots, which of course cannot be printed.

On the other hand, the biodegradability of this over-packaging is an advantage because these peat pots that are particularly ecological and with assured biodegradability, are not polluted by the over-packaging from the petroleum industry.

There can also be adjusted in an entirely appropriate manner the flexibility of the sheets of material thus obtained, with plastifiers, these latter being also biodegradable, selected from vegetable oils and their derivatives, ethyl ester of colza or of oleic acid.

The present application has been described as a result of numerous tests which have no limiting character.

1. Printable material with adjustable biodegradability, usable particularly for the production of horticultural containers and/or over-packaging for containers, characterized in that it comprises a mixture of polycaprolactone and polystyrene, including a vegetable load.

2. Printable material with adjustable biodegradability according to claim 1, characterized in that the mixture comprises 50 to 70% by weight of polycaprolactone and 50 to 30% of polystyrene, the vegetable load varying from 15 to 50% by weight of the whole.

3. Printable material with adjustable biodegradability, according to claim 1, characterized in that the vegetable load is 30% by weight of the whole.

4. Printable material with adjustable biodegradability, according to claim 1, characterized in that the vegetable load is selected from wheat and/or corn and/or cellulose.

5. Printable material with adjustable biodegradability, according to claim 1, characterized in that the mixture comprises 60% by weight of polycaprolactone and 40% of polystyrene, the vegetable load being 30% by weight of the whole.

6. Printable material with adjustable biodegradability, according to claim 5, characterized in that it incorporates a biodegradable plastifier selected from vegetable oils and their derivatves, ethyl ester of colza or oleic acid.

7. Process for the production of a sheet of material according to claim 1, characterized in that the obtained material is calandered.

8. Horticultural container or over-packaging for printable containers with adjustable biodegradability, made from a material according to claim 1, from a calandered sheet, for cutting out, folding and gluing.

9. Process for the production of a horticultural container and/or an over-packaging with adjustable biodegradabilty while maintaining printability using the material according to claim 1, characterized in that the quantity and nature of the vegetable load are varied so as to adjust the biodegradability, with substantially constant mechanical parameters.

10. Process for the production of a horticultural container and/or an over-packaging for containers, with adjustable biodegradability whilst preserving printability, characterized in that there is used a polycaprolactone of a molecular weight comprised between 6500 and 6800.

11. Printable material with adjustable biodegradability, according to claim 2, characterized in that the vegetable load is 30% by weight of the whole.

12. Printable material with adjustable biodegradability, according to claim 2, characterized in that the vegetable load is selected from wheat and/or corn and/or cellulose.

13. Printable material with adjustable biodegradability, according to claim 3, characterized in that the vegetable load is selected from wheat and/or corn and/or cellulose.
